(19) United States
(12) Patent Application Publication
(10) Pub. No.: US 2003/0220034 A1
(43) Pub. Date: Nov. 27, 2003

(54) Wheel house shell for a vehicle and method of making same

(75) Inventor: Juergen Ochs, Moensheim (DE)

Correspondence Address: CROWELL & MORING LLP, INTELLECTUAL PROPERTY GROUP, P.O. BOX 14300, WASHINGTON, DC, 20044-4300, US

(73) Assignee: Dr. Ing. h.c.F. Porsche Aktiengesellschaft.

(21) Appl. No.: 10/430,289

(22) Filed: May 7, 2003

(30) Foreign Application Priority Data
May 22, 2002 (DE) 102 22 440.4

(51) Int. Cl. B32B 5/18; B32B 3/00; B32B 5/02; B32B 5/22; B32B 9/00

(52) U.S. Cl. 442/76; 442/59; 442/402

(57) ABSTRACT

A wheel house shell for a vehicle has a multi-layer textile construction, in which case a covering layer is provided on the side of the wheel house shell facing the wheel. In order to avoid an absorption of water and dirt respectively by the covering layer, the latter is produced of a hydrophobic weave or knit made of PTFE fibers.

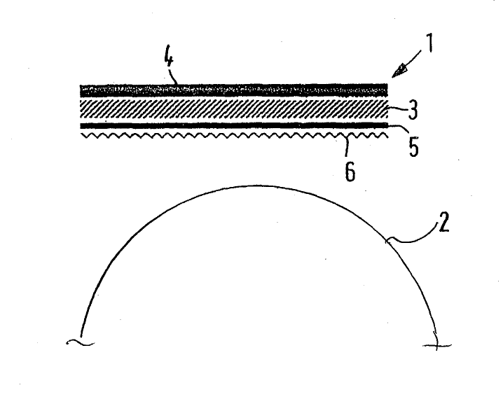

### BACKGROUND AND SUMMARY OF THE INVENTION

This application claims the priority of German Application No. 102 22 440.4 filed May 22, 2002, the disclosure of which is expressly incorporated by reference herein.

The invention relates to a wheel house shell for a vehicle, which has a multi-layer textile construction, a covering layer being provided on the side of the wheel house shell facing the wheel.

Wheel house shells of the initially mentioned type (German Patent Document DE 100 24 496 A1, corresponding U.S. patent Publication No. 2003/0011183) have positive acoustic and mechanical characteristics, whereby splashing water noises and stone throw noises are reduced. Furthermore, as a result of the textile construction, the weight is reduced. In the case of this arrangement, the covering layer facing the wheel is formed by a polyester non-woven. It is a disadvantage of this wheel house shell that, on the one hand, the polyester non-woven absorbs a considerable amount of water and that, on the other hand, dirt adheres particularly well to the relatively rough surface of the polyester non-woven. When vehicles equipped with the latter, for example, after a drive on dirt roads, are subsequently cleaned by means of a high-pressure cleaning device, the water absorbed by the covering layer of the wheel house shell will drip off for some time, which may result in undesirable puddles under the vehicle.

It is an object of the invention to further develop a textile wheel house shell of the initially mentioned type such that an absorption of water and dirt by way of the covering layer situated closest to the wheel is avoided.

According to the invention, this object is achieved by providing an arrangement wherein the covering layer consists of a hydrophobic weave or knit made of PTFE fibers. Additional characteristics further developing the invention in an advantageous manner are described herein and in the claims.

A principal advantage of the invention is that, as a result of the construction of the covering layer of a hydrophobic weave or knit made of PTFE fibers, no water or dirt is absorbed by way of the covering layer. The connection of this anti-adhesive surface material with the actual wheel house shell takes place by suitable thermoplastic bonding agents or by a mechanical fixing (for example, needle bonding).

Other objects, advantages and novel features of the present invention will become apparent from the following detailed description of the invention when considered in conjunction with the accompanying drawings.

### BRIEF DESCRIPTION OF THE DRAWING

The single drawing FIGURE is a schematic view of a section of a multi-layer textile wheel house shell constructed according to preferred embodiments of the present invention.

### DETAILED DESCRIPTION OF THE DRAWING

The single FIGURE is a schematic view of the construction of a multi-layer textile wheel house shell 1 of a vehicle. For characterizing the position, a partial area of the adjoining wheel 2 is schematically outlined.

In the embodiment shown, the wheel house shell 1 comprises a relatively thick embedded non-woven layer 3 which is surrounded by layers 4, 5 on both sides. The construction of such a wheel house layer is described in detail, for example, in German Patent Document DE 100 24 496 A1. On the side facing the wheel 2, a covering layer 6 is arranged. According to the invention, this covering layer 6 consists of a hydrophobic weave or knit of PTFE fibers (polytetrafluor ethylene fibers). Such fibers are generally known under the name “Teflon” fibers (trade name “Teflon” by DuPont).

The connection of this anti-adhesive surface material with the actual wheel house shell 1 takes place by suitable thermoplastic bonding agents or by a mechanical fixing (for example, by needle bonding).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Wheel house shell for a vehicle, which has a multi-layer textile construction, a covering layer being provided on the side of the wheel house shell facing the wheel,
wherein the covering layer consists of a hydrophobic weave or knit made of PTFE fibers.

2. Wheel house shell according to claim 1, wherein the hydrophobic covering layer is connected with the wheel house shell by means of a thermoplastic bonding agent.

3. Wheel house shell according to claim 1, wherein the hydrophobic covering layer is connected with the wheel house shell by a mechanical fixing (for example, needle bonding).

4. A method of making a wheel house shell for a vehicle, which has a multi-layer textile construction, a covering layer being provided on the side of the wheel house shell facing the wheel,
wherein the covering layer consists of a hydrophobic weave or knit made of PTFE fibers,
said method comprising one of:
(i) bonding the hydrophobic covering layer with the wheel house shell with a thermoplastic bonding agent, and
(ii) mechanically fixing the hydrophobic layer to the wheel house shell by a needle bonding.

5. A method according to claim 4, wherein said method comprises bonding the hydrophobic covering layer with the wheel house shell with a thermoplastic bonding agent.

6. A method according to claim 4, wherein said method comprises mechanically fixing the hydrophobic layer to the wheel house shell by a needle bonding.
